(19) United States
(12) Patent Application Publication
(10) Pub. No.: US 2008/0156618 A1
(43) Pub. Date: Jul. 3, 2008

(54) High capacity delivery with priority handling

(75) Inventor: Michael D. Brain, Monte Sereno, CA (US)

Correspondence Address: CARR & FERRELL LLP, 2200 GENG ROAD, PALO ALTO, CA, 94303, US

(73) Assignee: Aquest Systems Corporation

(21) Appl. No.: 12/002,850

(22) Filed: Dec. 18, 2007

Related U.S. Application Data
(63) Continuation-in-part of application No. 11/764,755, filed on Jun. 18, 2007.
Application No. 11/764,755 is a continuation-in-part of application No. 11/406,569, filed on Apr. 18, 2006, now Pat. No. 7,281,623.

(51) Int. Cl. B65G 49/07; G06F 7/00

(52) U.S. Cl. 198/349.6; 198/370.01; 700/226

(57) ABSTRACT

Systems and methods are provided for transporting articles throughout a fabrication facility according to assigned priority levels. Systems of the present invention are directed to conveyor systems that may include parallel conveyors and nodes where articles can be switched between conveyors. Accordingly, high priority articles can be routed around traffic by switching between parallel conveyors and/or lower priority articles can be rerouted or buffered to make a chosen route for a high priority article less congested. Methods are directed to selecting the most appropriate route for an article amongst the various possible routing alternatives.

### CROSS-REFERENCE TO RELATED APPLICATIONS

This application is a continuation-in-part of U.S. application Ser. No. 11/764,755 filed on Jun. 18, 2007 and entitled “Conveyor System Including Offset Section” which is a continuation-in-part of U.S. application Ser. No. 11/406,569 filed on Apr. 18, 2006 and entitled “Transport System Including Vertical Rollers,” now U.S. Pat. No. 7,281,623 issued on Oct. 16, 2007, which claimed the benefit of U.S. Provisional Application No. 60/840,169 filed on Aug. 25, 2006 and entitled “High Speed Transporter Including Horizontal Belt,” U.S. Provisional Application No. 60/805,085 filed Jun. 18, 2006 and entitled “High Capacity Delivery with Priority Handling,” and U.S. Provisional Application No. 60/805,084 entitled “Pulley and Belt Profiles for Transport System Including Vertical Rollers” and also filed on Jun. 18, 2006. This application is also related to U.S. application Ser. No. 11/897,013 filed on Aug. 27, 2007 and entitled “Conveyor Transfer System;” U.S. application Ser. No. 11/983,353 filed on Nov. 7, 2007 and entitled “Integrated Overhead Transportation System with Stationary Drive;” and U.S. application Ser. No. 11/764,161 filed on Jun. 15, 2007 and entitled “Transport System including Vertical Rollers.” Each of the aforementioned applications is incorporated herein by reference.

### BACKGROUND OF THE INVENTION

1. Field of the Invention

The present invention relates generally to the field of transport systems and more particularly to prioritizing or assuring the timely delivery of articles therewith.

2. Description of the Prior Art

In semiconductor and other fabrication facilities there is a significant advantage to transporting work in process material at higher speeds throughout the facility while maintaining a high transport capacity with timely and predictable delivery times. There may also be an advantage to designating the transport of some material as having a higher priority than the transport of other material.

In semiconductor fabrication facilities particularly, semiconductor wafers are transported inside a carrier, called a FOUP, which is an acronym for Front Opening Unified Pod. The FOUP can be transported, for example, on a high speed device such as that disclosed in U.S. Pat. No. 7,281,623 issued on Oct. 16, 2007 and entitled “Transport System Including Vertical Rollers.” In that patent, a system is disclosed that can move FOUPs at high speeds supported between moving transport belts. As the FOUP approaches the vicinity of a next step in the process flow, the FOUP is transferred to a buffer location, to another transport mechanism, or directly to process or metrology equipment.

### SUMMARY

An exemplary system for transporting articles comprises a conveyor system and a computing system. The conveyor system includes a plurality of conveyors arranged to transport articles between multiple destinations and also includes a plurality of nodes at which articles can be transferred between conveyors. The computing system is configured to select, based on a priority level assigned to an article, a route for the article through the conveyor system to a destination. In various embodiments, a node of the plurality of nodes can include a turntable or an elevator. A conveyor of the plurality of conveyors can comprise two vertical belts, in some embodiments. Further, the conveyors of the plurality of conveyors can be arranged in a plurality of layers, and in some of these embodiments a layer of the plurality of layers can comprise a transport layer or a buffer layer, for example.

An exemplary method of the invention is directed to routing a first article having a priority level through a conveyor system. The exemplary method comprises determining for the first article a primary delivery route through the conveyor system to a destination, determining a second article that can be rerouted or delayed, the second article having a priority level lower than the priority level of the first article, and estimating a delivery time to deliver the first article to the destination by conveying the first article along the primary delivery route in a scenario in which the second article is rerouted or delayed. The exemplary method can also comprise delivering the first article to the destination by conveying the first article along the primary delivery route. The exemplary method can further comprise comprising simulating the delivery of the first article to the destination before delivering the first article to the destination.

In some embodiments of the exemplary method, determining the primary delivery route includes checking a database for an optimal route, while in other embodiments determining the primary delivery route includes executing a routing algorithm to find the optimal route. Determining the second article that can be rerouted can include, in some instances, determining that a score for rerouting the second article is less than a score for routing the first article. Delivering the first article can include rerouting the second article, in some embodiments. The exemplary method can also comprise determining a third article that can be rerouted, where the third article has a priority level lower than the priority level of the first article, and estimating a delivery time to deliver the first article to the destination by conveying the first article along the alternate delivery route in a scenario in which the third article is rerouted.

The present invention further provides a computer readable medium having stored thereupon computing instructions. The computing instructions comprise a code segment to determine for a first article a primary delivery route through a conveyor system to a destination, a code segment to determine a second article that can be rerouted, the second article having a priority level lower than the priority level of the first article, and a code segment to estimate a delivery time to deliver the first article to the destination by conveying the first article along the primary delivery route in a scenario in which the second article is rerouted.

The code segment to determine the primary delivery route, in some instances, includes a code segment to check a database for an optimal route, while in other instances the code segment to determine the primary delivery route includes a code segment for a routing algorithm to find the optimal route. In some embodiments of the computer readable medium, the computing instructions further comprise a code segment to determine a score for routing the first article and a score for rerouting or delaying the second article. In some of these embodiments, the code segment to determine the second article that can be rerouted or delayed includes a code segment to compare the score for routing the first article to the score for rerouting or delaying the second article. In other instances, the code segment to determine the score for routing the first article and the score for rerouting or delaying the second article is configured to determine the respective scores by multiplying a value representing a priority level for each article by a weighting factor.

### BRIEF DESCRIPTION OF DRAWINGS

FIG. 1 is a side view of a portion of a conveyor system within a fabrication facility, according to an embodiment of the present invention.

FIG. 2 is a top view of a portion of a conveyor system within a fabrication facility, according to an embodiment of the present invention.

FIG. 3 is an end view of a portion of a conveyor system within a fabrication facility, according to an embodiment of the present invention.

FIG. 4 is a top view of a portion of a conveyor system within a fabrication facility, according to an embodiment of the present invention.

FIG. 5 is a flowchart representation of a method of determining a route for an article through a conveyor system, according to an embodiment of the present invention.

FIG. 6 is a schematic illustration of a system of hardware emulation for performing simulations, according to an embodiment of the present invention.

### DETAILED DESCRIPTION OF THE INVENTION

The present invention is directed to systems and methods for transporting articles, such as flat panel displays and semiconductor wafers within FOUPs, throughout a fabrication facility. According to the present invention, the articles can be assigned varying degrees of priority, and the articles can be moved more or less expeditiously to their destinations based on these priority levels. Overall system efficiency is improved by minimizing cycle times, by assuring that articles arrive at intended destinations within desired time windows, and by assuring that articles arriving at an intended destination arrive in a desired sequence. To achieve these goals, the present invention provides a conveyor system that allows for alternative routing choices by including alternate routes such as parallel conveyors and nodes where articles can be switched between conveyors, the use of a hoist to bypass congested conveyor portions, or the use of buffering to hold traffic of lower priority. Accordingly, high priority articles can be routed around traffic by switching between parallel conveyors and/or lower priority articles can be rerouted or delayed to make a route less congested. Methods are provided for selecting the most appropriate route for an article amongst the various routing alternatives to increase overall efficiency and to optimize the delivery of articles according to assigned priorities.

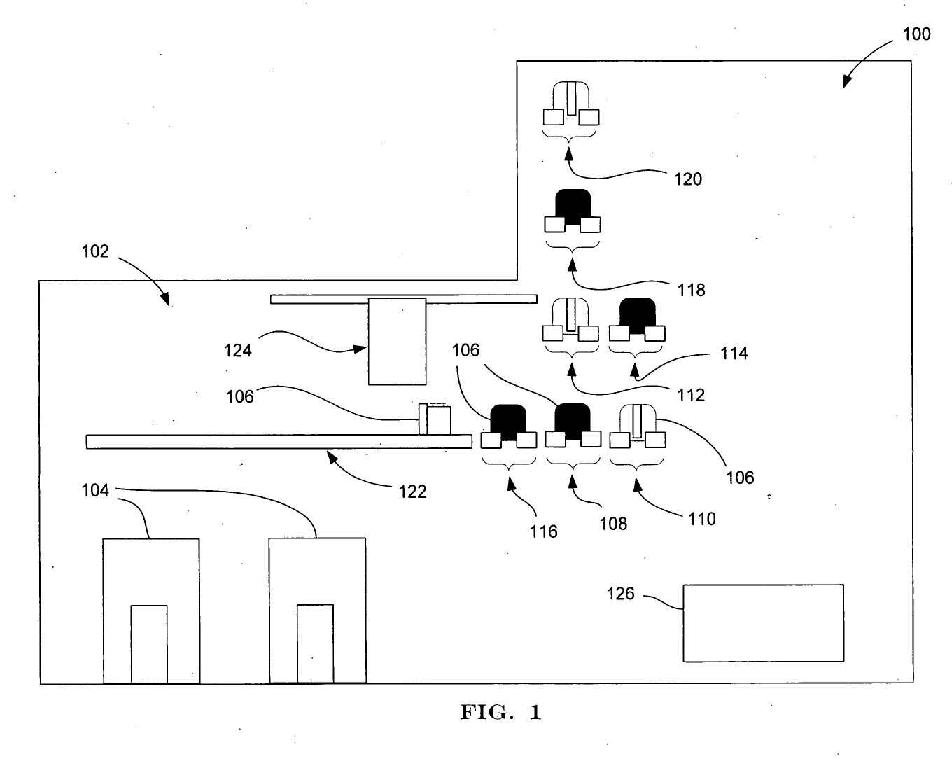

FIG. 1 illustrates a side view of an exemplary portion of a conveyor system within a fabrication facility. The illustrated portion comprises a central corridor 100 and an area 102 for process and/or metrology equipment 104. As can be seen in FIG. 1, a ceiling of the central corridor 100 can be higher than a ceiling of the area 102. It will be appreciated that the central corridor 100 can link multiple such areas 102 within the fabrication facility.

In FIG. 1, FOUPs 106 are transported along the central corridor 100 between areas 102 by conveyors 108, 110 in opposite transport directions that are perpendicular to the plane of the drawing. The central corridor 100 can optionally also comprise additional conveyors 112, 114 to provide additional transportation capacity and alternative routes through the fabrication facility. Such additional capacity can allow for load balancing as well as redundancy in the event of a failure. These additional conveyors 112, 114 can further be used to temporarily store FOUPs 106 in some instances. In some embodiments, the additional conveyors 112, 114 are reserved for use only by those FOUPs 106 with sufficiently high priority levels.

The additional conveyors 112, 114 are disposed above the conveyors 108, 110 in FIG. 1 but are not limited to this arrangement and can be alternatively disposed below or along side the conveyors 108, 110, for example. Further, it will be appreciated that the central corridor 100 can comprise still more conveyors than the two additional conveyors 112, 114. Also shown in FIG. 1 are a buffer conveyor 116 and two storage conveyors 118, 120. The functions of the various conveyors will be described in greater detail below.

The fabrication facility additionally comprises a conveyor 122 for conveying FOUPs 106 along the length of the area 102 and to and from the conveyors within the central corridor 100. In some embodiments, a mechanism such as a hoist 124 is used to transfer FOUPs 106 between the conveyor 122 and the equipment 104. Exemplary mechanisms for transferring FOUPs 106 between the conveyor 122 and the equipment 104 are described in U.S. application Ser. No. 11/983,353 filed on Nov. 7, 2007 and entitled “Integrated Overhead Transportation System with Stationary Drive.”

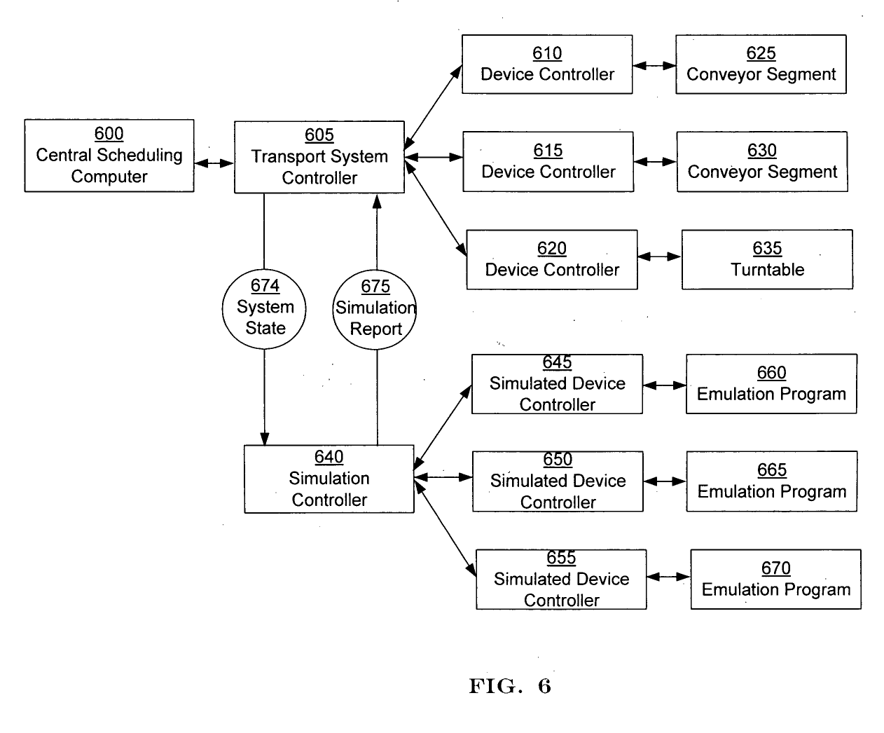

The fabrication facility additionally comprises a computing system 126. The computing system 126 communicates with the process and metrology equipment 104 and the transport system device controllers that control the various conveyors and associated transfer mechanisms to implement methods of the invention described below. Aspects of the computing system 126 are described in more detail with respect to FIG. 6.

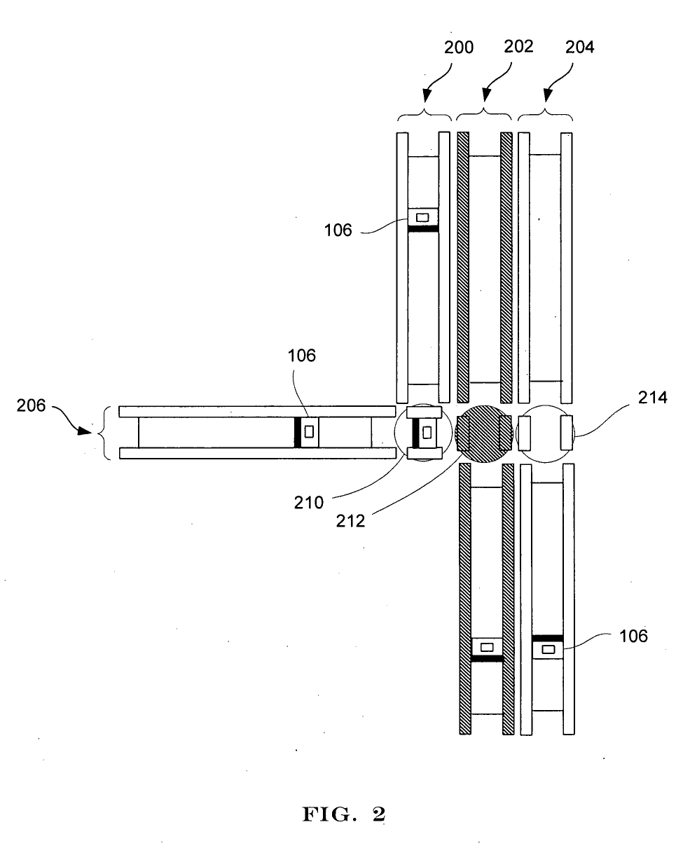

FIG. 2 illustrates a top view of a portion of an exemplary conveyor system within a fabrication facility. In FIG. 2, three parallel conveyors 200, 202, 204 extend within a central corridor (e.g. central corridor 100 of FIG. 1) and are met by a conveyor 206 disposed perpendicular to the conveyors 200, 202, 204 and extending within an area (e.g. area 102 of FIG. 1) for process and/or metrology equipment (e.g. equipment 104 of FIG. 1). Each of the conveyors 200, 202, 204, 206 in the illustrated embodiment comprises two belts for transporting FOUPs 106 therebetween, although it will be appreciated that other types of transportation can be used in place of these conveyors. Of the three conveyors 200, 202, 204, two conveyors 200, 202 are used to transport FOUPs 106 in opposite directions, as shown, while the third conveyor 204 serves as a buffer conveyor.

In the embodiment illustrated by FIG. 2, a turntable 210 comprises a node between the conveyors 204 and 206 at which FOUPs 106 can be transferred from one conveyor 204, 206 to the other 206, 204. Additional turntables 212, 214 are disposed between conveyor segments of the conveyors 200, 202. Suitable turntables are described in more detail in U.S. application Ser. No. 11/818,657 filed on Jun. 14, 2007 and titled “Systems and Methods for Transport Through Curves.” A node for transferring FOUPs 106 between two parallel conveyors 202, 204 exists where each conveyor 202, 204 includes an adjacent turntable 212, 214. In FIG. 2, the turntables 212, 214 in line with the turntable 210 so that FOUPs 106 can also be routed between conveyor 206 and either of the two conveyors 200, 202.

Any of the turntables 210, 212, 214 can be configured with an elevator that will allow a FOUP 106 to be moved vertically to another conveyor in a higher or lower layer than the illustrated layer. Any of the turntables 210, 212, 214 can also be replaced by other FOUP 106 transfer mechanisms. Other suitable transfer mechanisms are described in U.S. application Ser. No. 11/897,013 filed on Aug. 27, 2007 and entitled “Conveyor Transfer System.”

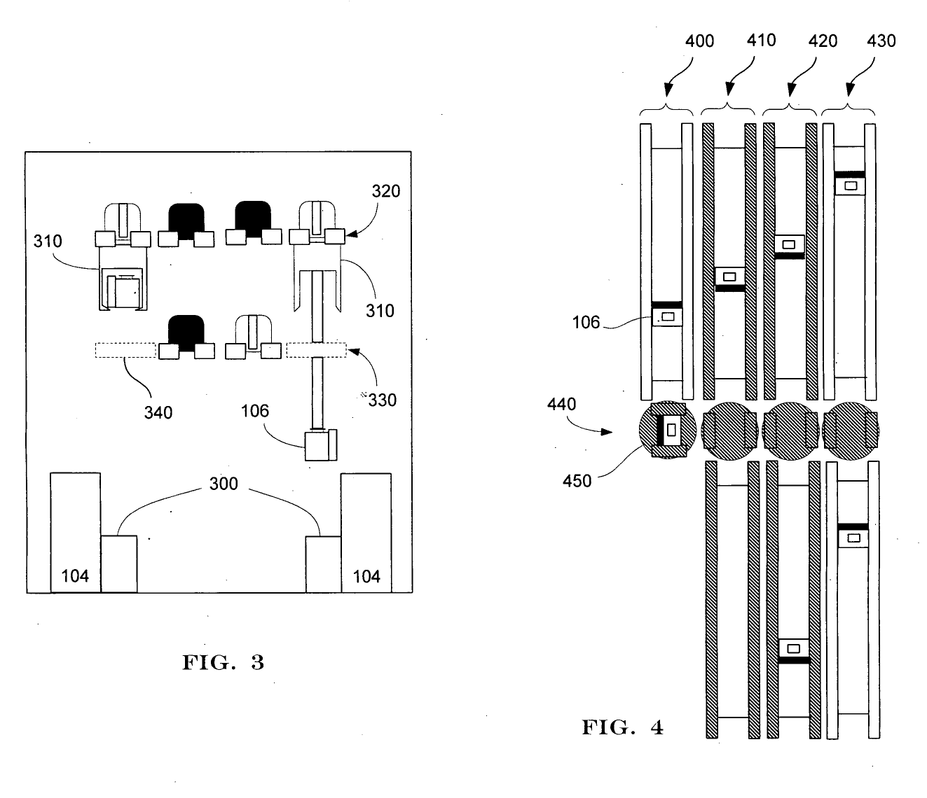

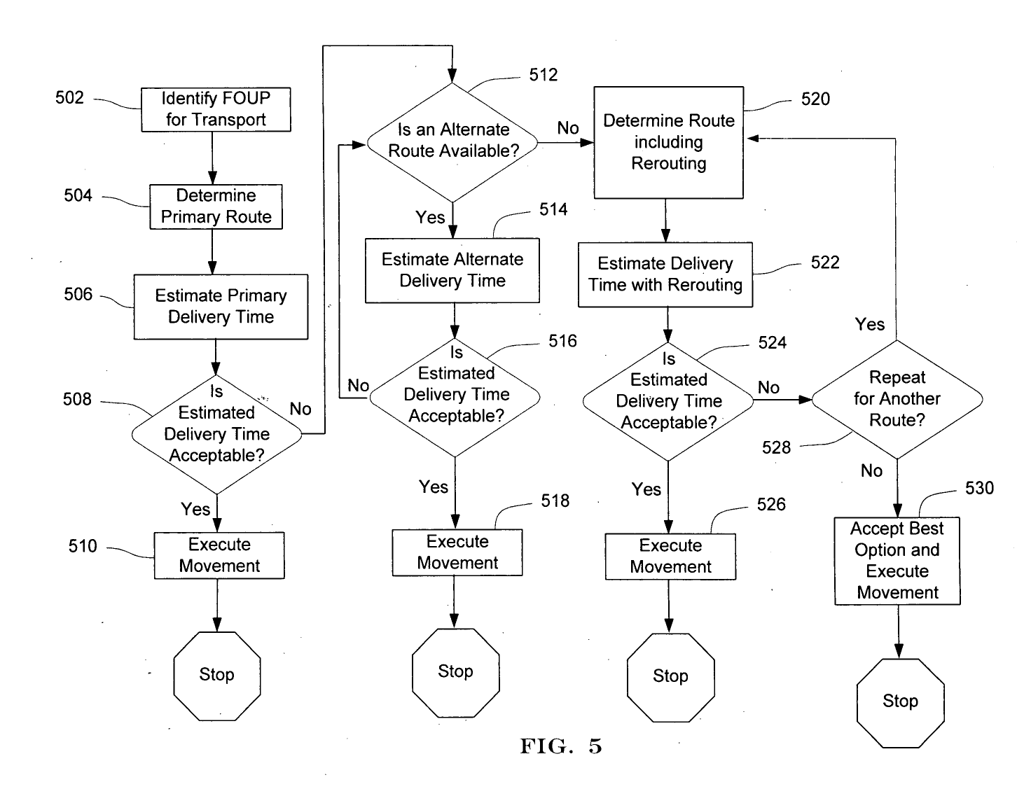

FIGS. 3 and 4 show an end view and a top view, respectively, of an exemplary aisle such as would run the length of the area 102 (FIG. 1). Since factory space is expensive, especially in a clean factory such as is necessary for semiconductor or flat panel fabrication, it is desirable to minimize the footprint of the fabrication facility which can be achieved, at least in part, by making the aisles between equipment 104 as narrow as possible. In some embodiments, the load ports 300 of the equipment 104 are located close together, such as 1.6, 2.0, or 2.4 meters from load port center line to center line. In FIG. 3, exemplary hoists 310 are used to transfer FOUPs 106 between the equipment load ports 300 and the overhead conveyors.

As noted above with respect to the conveyors in the central corridor 100 (FIG. 1), multiple transport and buffering conveyors can be arranged in layers in the space above the aisle. One such layer, illustrated by FIG. 4, includes a buffer conveyor 400, three transport conveyors 410, 420, 430, and a node 440 comprising four turntables 450. Such conveyors 400, 410, 420, 430 and nodes 450 allow FOUPs 106 with higher priorities to be delivered more rapidly, while FOUPs 106 with lower priorities may continue to be transported or may be buffered.

In some embodiments, one or more layers of conveyors are used to transport FOUPs 106 into and out of the aisle, while another layer of conveyors is provided for buffering FOUPs 106. If the equipment 104, or a hoist 310 configured to service the equipment 104, are not immediately ready to receive a FOUP 106 that is brought into the aisle in a transport layer 320, the FOUP 106 may be transferred to a buffer layer 330 where the FOUP 106 can be held until the equipment 104 is available. The FOUP 106 can be transferred between transport layer 320 and buffer layer 330, for example, with an elevator (not shown) configured to raise and lower a turntable 450. FOUPs 106 held in the buffer layer 330 will not interfere with the transport of FOUPs 106 in the transport layer 320. When a FOUP 106 is to be retrieved from the buffer layer 330, the FOUP 106 may be moved to a buffer transfer port 340 for a hoist 310 to pick up and deliver to the equipment load port 300. In one alternative embodiment of the invention, the transport layer 320 is disposed below the buffer layer 330.

As shown in FIG. 4, FOUPs 106 within a layer can be transferred between conveyors 400, 410, 420, 430 in the layer at nodes 440. A node can also comprise a mechanism for transferring a FOUP 106 between conveyors within different layers, such as a turntable 450 configured with an elevator. It will be appreciated that if any portion of the conveyor system fails or is blocked with traffic at any time, conveyors within a layer or within other layers, and the nodes that connect the various conveyors, can be used to provide a route around the problem. The use of turntables and elevators in this manner is equally applicable to routing around problems within the central corridor 110.

An exemplary method of selecting a route for a FOUP through a semiconductor fabrication facility is illustrated by the flowchart in FIG. 5. Even though the method is described in terms conveying FOUPs for transporting semiconductor wafers, it will be appreciated that the method is generally applicable to routing articles through fabrication facilities dedicated to manufacturing other devices, such as flat panel displays. The steps of the method described below can be performed, for example, by a computing system (e.g. computing system 126 of FIG. 1).

The method shown in FIG. 5 begins in a step 502 of identifying a FOUP that is ready for transport. For instance, the FOUP may be disposed at a first location (a.k.a. the source) and loaded with wafers that are ready for metrology or processing at a second location (a.k.a. the destination). Here, the FOUP can be identified, for example, by receiving a signal from a metrology or processing tool that the door of the FOUP has been closed. Step 502 can include assigning a priority level to the FOUP based on considerations such as the whether the destination metrology or processing tool is immediately available, or already has FOUPs in process or waiting.

In a step 504 a determination is made of a primary route from the source to the destination. The determination can be made by checking a database or by executing a routing algorithm that can find the shortest route, in various embodiments. While in some instances the primary route that is determined in step 504 comprises a physical path through the conveyor system, it will be appreciated that the primary route can also comprise a timing element, as well. In some embodiments, the primary route also specifies for the FOUP a scheduling slot the route. Scheduling slots are also referred to as time slices herein, and an exemplary time slice is 15 seconds.

Next, in a step 506, a primary delivery time is estimated for the primary route. The primary delivery time may be estimated by calculating the distance to be traveled multiplied by an average expected speed, for example. The average expected speed may be a set constant or can be determined based on the current or expected volume of traffic on the primary route. The primary delivery time may also be estimated by more complex methods that model the delivery times for the individual conveyors and other components of the primary route. For the purposes of such modeling, or for making a determination of the average expected speed, the amount of traffic already on, or expected on, the primary route can be determined.

In a step 508, a determination is made as to whether or not the primary delivery time is acceptable. This determination can be made by comparing the primary delivery time to a desired arrival time. The desired arrival time can be provided by a scheduling algorithm, in some embodiments. In other instances, each level of priority is associated with a range of acceptable transport times or a maximum acceptable transport time. Thus, the desired arrival time for a FOUP with an assigned priority level can be determined by cross-referencing the priority level against a table. If the primary delivery time meets the desired time, then the primary delivery time is acceptable and the transport movement of the FOUP according to the primary route is executed in a step 510.

On the other hand, if the primary delivery time is not acceptable, then an alternate route from the source to the destination may be determined in a step 512. As in step 504, the determination can be made by checking the database or by executing the routing algorithm to find the next shortest route, in various embodiments. Due to traffic or other such problems, the alternate route may include the use of buffer conveyors in the transport or buffer layers, as described above.

If an alternate route is available, then in step 514 a secondary delivery time is calculated for the alternate route as described above with respect to step 506. A determination is then made in a step 516 as to whether or not the secondary delivery time is acceptable as described above with respect to step 508. If the secondary delivery time meets the desired time, then the secondary delivery time is acceptable and the transport movement of the FOUP according to the secondary route is executed in a step 518.

If the secondary delivery time is not acceptable, then steps 512-516 can be repeated until either an acceptable route is found, all alternate routes have been tested, or a threshold number of iterations through steps 512-516 has been met. If no acceptable alternate route is found then in a step 520 a determination can be made as to whether rerouting one or more FOUPs would make a delivery time for the primary or any alternate routes acceptable.

In some embodiments, FOUPs considered for rerouting are those FOUPs having lower assigned priority levels. Rerouting a FOUP can comprise, for example, moving the FOUP onto a buffer conveyor or onto another transport conveyor. Rerouting a FOUP can also comprise holding a FOUP from entering the transport system until after the higher priority FOUP has passed. In some embodiments, step 520 includes identifying and resolving specific instances of routing conflicts between FOUPs, as discussed further below.

In a step 522 another primary delivery time is calculated for the primary route as described above with respect to step 506, but in this instance taking into account the proposed rerouting of certain FOUPs. A determination is then made in a step 524 as to whether or not the newly calculated delivery time is acceptable as described above with respect to step 508. If acceptable, the transport movement of the FOUP according to the primary route along with the rerouting of the certain FOUPs are executed in a step 526. If not acceptable, a determination can be made in a step 528 as to whether to repeat steps 520-524 with a previously considered alternate route. In some embodiments, the determination to repeat steps 520-524 is made so long as previously identified alternate routes have not yet been tested with rerouting. In other embodiments, if a threshold number of alternate routes have already been tested with rerouting, a determination not to repeat steps 520-524 is made. If no acceptable combination of an alternative route with rerouting of certain FOUPs exists, then the best option amongst the options previously deemed unacceptable is selected and the movement of the FOUP, and the rerouting of certain other FOUPs, if beneficial, is executed in a step 530.

Referring again to step 520, if low priority FOUPs are rerouted to allow a higher priority FOUP to reach a destination more rapidly, a traffic jam can result much like a presidential limousine and entourage can cause a traffic problem when given priority over regular traffic in an urban rush hour. To prevent this, some embodiments of the invention include systems and methods of accommodating a higher priority FOUP with reduced effect on other traffic.

For instance, in some embodiments, a score is calculated for each FOUP movement, where a FOUP movement represents the act of transporting a FOUP to a destination such as process or metrology equipment. The scores can then be used to evaluate routing decisions in step 520. The score for a FOUP can simply be a function of the priority level for the FOUP, or can be further modified based on various considerations. In one example, 10 points are allotted to any FOUP assigned the highest priority. If a process or metrology equipment will sit idle until the FOUP arrives, then the 10 points assigned to the FOUP is multiplied by a weighting factor that represents the length of time the equipment will be idle or the cost of having the equipment sit idle. These weighting factors may be dependent on the particular equipment and/or the overall load and capacity of the particular equipment and/or the expected impact on facility output.

Continuing with the example above, a weighting factor for a particular equipment at a particular time is given a value of 10. In this case, the 10 points assigned to the FOUP to designate the highest priority level are multiplied by the weighting factor of 10 to determine an overall score for the FOUP movement of 100. When a potential route to deliver this FOUP is evaluated in step 520, any FOUP movement scoring less than 100 points along the route under evaluation can be considered for rerouting. Any FOUP movement scoring 100 points or more would not be considered for rerouting.

To prevent traffic jams of the sort mention above, in some embodiments, the sum of the scores of any proposed rerouted FOUP movements cannot exceed the score of the FOUP movement being evaluated. Thus, a 100 point FOUP movement will take priority over two 40 point FOUP movements but would not take priority over two 90 point FOUP movements or over six 20 point FOUP movements.

In addition to the cost of having equipment sit idle, weighting factors can also be based on a cost of having a FOUP wait. The score for a FOUP movement, therefore, can be calculated in some embodiments by multiplying the points assigned to the FOUP to designate priority by a weighting factor based on the wait time. While a weighting factor can simply be proportional to the wait time, the weighting factor may also be adjusted to take into account that the cost of having a FOUP 106 wait may be a function of the availability schedule of equipment. For example, the cost of having a FOUP wait is reduced if the destination equipment is already in use and will still be unavailable when the FOUP arrives after the proposed wait. Certain equipment may be designated as bottleneck equipment, whose capacity has more direct impact on the factory output and therefore preventing this equipment from being idle will be given a higher weighting. Such costs may be calculated for a number of time slices in the future, and weighting factors can be dependent upon the costs as a function of time. Additionally, it will be understood that calculating a score for a FOUP movement is not limited to multiplying together a number of points for a priority level by every weighting factor, but can alternatively include, for instance, adding the products of the priority points with several weighting factors.

In some embodiments, determining whether a FOUP should be rerouted in step 520 can include adjusting the score of the FOUP movement for that FOUP to account for the costs of rerouting that FOUP. It will be appreciated that a cost analysis can be incorporated into the method illustrated by FIG. 5 and may include several stages. For example, at step 506 a first cost analysis of the cost of taking the primary route can be performed along with the estimation of the primary delivery time. In some embodiments, even if the primary delivery time is acceptable, the method may then continue to determine an alternate route and a cost of taking the alternate route. Where the cost of taking the alternate route is lower than that of the primary route, if the secondary delivery time is still acceptable, would make the alternate route more desirable than the primary route. The same analysis can continue by considering routes in which other FOUPs are rerouted. In some embodiments, other approaches seek to minimize the total costs and/or maximize the system wide benefits of routing decisions.

To further improve the system wide performance, the system may determine if a lower priority FOUP or FOUP movement in the route of a higher priority FOUP will actually impact the delivery time of the priority FOUP. In some embodiments, this is accomplished by examining a plurality of pending FOUP movements in a database, analyzing the pending FOUP movements by time slice, and locating route intersections. In some embodiments, when two FOUP routes are predicted to interfere, the lower priority FOUP movement can be diverted to another route or kept on the same route but either sped up or delayed to avoid the predicted conflict. In some embodiments, speeding up or delaying a FOUP can be accomplished by moving the FOUP into a different time slice for the route. In some embodiments, a simulation of the real system is created to determine the routes' intersections. The simulation can then be re-run with the lower priority FOUP movements rerouted to verify that new conflicts have not been created.

FIG. 6 illustrates a system of hardware emulation for performing simulations as described above. The system comprises a central scheduling computer 600 configured to issue movement commands to a transport system controller 605 which in turn is configured to send individual movement commands to exemplary transport system device controllers 610, 615, and 620 which control individual transport mechanisms such as conveyor segments 625, 630 and turntable 635.

Prior to initiating a FOUP movement, the transport system controller 605 may send the system state 674 (e.g., the current system status and current movement command queue) to a simulation controller 640 that may be a second instance of the transport system controller 605 and is provided to perform simulations. The simulation controller 640 may include a copy of the controller logic (e.g., software) and/or a copy of the controller hardware (e.g., processor and/or firmware). The simulation controller 640 is connected to a network of simulators 645, 650, 655 of the transport system device controllers 610, 615, 620. While the simulators 645, 650, 655 can be complete duplicates of the transport system device controllers 610, 615, 620, the simulators 645, 650, 655 can instead be merely copies of the device control programs being executed by the transport system device controllers 610, 615, 620. Accordingly, the simulators 645, 650, 655 need not be spatially separate as suggested by FIG. 6, but can be operating on a single computing system, even the same computing system of the simulation controller 640.

Since the simulators 645, 650, 655 do not control actual devices, the simulators 645, 650, 655 are instead connected to device emulation programs 660, 665 and 670. The device emulation programs 660, 665, 670 accept the motor and digital output commands from the simulators 645, 650, 655 and respond with status replies and digital output data that precisely emulate the actual transport mechanisms.

After a simulation of a FOUP movement has been completed, the simulation controller 640 can output a simulation report 675. The simulation report 675 can be a simple pass/fail indication, a summary of conflicts or near-conflicts that would occur if the FOUP movement were to actually be performed, or a detailed representation of the positions of the various FOUPs 106 as a function of time. The simulation report 675 can be transmitted back to the transport system controller 605 so that the transport system controller 605 can either initiate the proposed FOUP movement or propose a different FOUP movement back to the simulation controller 640. The simulation report 675 can also be used as feedback to validate the accuracy of the simulation.

By constructing the simulation environment to operate at a higher speed than the actual environment, the simulation report 675 may be obtained quickly so that the results therein can be used by the transport system controller 605 or other factory control systems or personnel to make better decisions. A variety of different time slices may be useful depending on factors such as the number of FOUP movements currently in process or in the queue, or the length of time required to complete those movements. In the event that events in the actual system do not match those estimated by the simulation, an early warning of system problems may be generated.

In alternative embodiments, simulation of system performance is performed using a distributed approach. In some of these embodiments, each routing element of a distributed system has a local controller responsible for a portion of the system. Each local controller is aware of the FOUPs 106 that are intended to enter that portion as input and configured to estimate when those FOUPs 106 will leave the portion as output. The local controller can then predict when each FOUP 106 will be delivered as output and communicate that information to another local controller for a neighboring portion that will receive the FOUP 106. Though a full series of these communications each local controller will then build a full list of the FOUPs 106 that are expected through the next number of minutes, for example two, five, 10, or 20 minutes. Then, if central scheduling computer 600 wishes to send a new FOUP 106 along a route, then each local controller along the route can be given a request to schedule the new FOUP 106 with a given priority. As each local controller stores this reservation and calculates an output time, that local controller can check for any conflicts to other reservations. Such conflicts can then be reported to the transport system controller 605 for resolution. Alternatively, the local controller could act to give the proper movement priority and notify subsequent local controllers of the updated reservation times for any effected FOUPs 106.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A system for transporting articles comprising:
a conveyor system including a plurality of conveyors arranged to transport articles between multiple destinations and including a plurality of nodes at which articles can be transferred between conveyors; and
a computing system configured to select, based on a priority level assigned to an article, a route for the article through the conveyor system to a destination.

2. The system of claim 1 wherein a conveyor of the plurality of conveyors comprises two vertical belts.

3. The system of claim 1 wherein a node of the plurality of nodes includes a turntable.

4. The system of claim 1 wherein a node of the plurality of nodes includes an elevator.

5. The system of claim 1 wherein the conveyors of the plurality of conveyors are arranged in a plurality of layers.

6. The system of claim 5 wherein a layer of the plurality of layers comprises a transport layer.

7. The system of claim 5 wherein a layer of the plurality of layers comprises a buffer layer.

8. A method for routing through a conveyor system a first article having a priority level, the method comprising:
determining for the first article a primary delivery route through the conveyor system to a destination;
determining a second article that can be rerouted, the second article having a priority level lower than the priority level of the first article;
estimating a delivery time to deliver the first article to the destination by conveying the first article along the primary delivery route in a scenario in which the second article is rerouted; and
delivering the first article to the destination by conveying the first article along the primary delivery route.

9. The method of claim 8 wherein determining the primary delivery route includes checking a database for an optimal route.

10. The method of claim 8 wherein determining the primary delivery route includes executing a routing algorithm to find an optimal route.

11. The method of claim 8 wherein determining the second article that can be rerouted includes determining that a score for rerouting the second article is less than a score for routing the first article.

12. The method of claim 8 wherein delivering the first article includes rerouting the second article.

13. The method of claim 8 further comprising
determining for the first article an alternate delivery route through the conveyor system to the destination;
determining a third article that can be rerouted, the third article having a priority level lower than the priority level of the first article; and
estimating a delivery time to deliver the first article to the destination by conveying the first article along the alternate delivery route in a scenario in which the third article is rerouted.

14. The method of claim 8 further comprising simulating the delivery of the first article to the destination before delivering the first article to the destination.

15. A computer readable medium having stored thereupon computing instructions comprising:
a code segment to determine for a first article a primary delivery route through a conveyor system to a destination;
a code segment to determine a second article that can be rerouted or delayed, the second article having a priority level lower than the priority level of the first article; and
a code segment to estimate a delivery time to deliver the first article to the destination by conveying the first article along the primary delivery route in a scenario in which the second article is rerouted or delayed.

16. The computer readable medium of claim 15 wherein the code segment to determine the primary delivery route includes a code segment to check a database for an optimal route.

17. The computer readable medium of claim 15 wherein the code segment to determine the primary delivery route includes a code segment for a routing algorithm to find an optimal route.

18. The computer readable medium of claim 15 further comprising a code segment to determine a score for routing the first article and a score for rerouting or delaying the second article.

19. The computer readable medium of claim 18 wherein the code segment to determine the second article that can be rerouted or delayed includes a code segment to compare the score for routing the first article to the score for rerouting or delaying the second article.

20. The computer readable medium of claim 18 wherein the code segment to determine the score for routing the first article and the score for rerouting or delaying the second article is configured to determine the respective scores by multiply a value representing a priority level for each article by a weighting factor.
